(19) United States
(12) Patent Application Publication
(10) Pub. No.: US 2010/0314892 A1
(43) Pub. Date: Dec. 16, 2010

(54) APPARATUS FOR LIFTING AND HANDLING ARTICLES

(76) Inventor: Barry Evans, Deeside (GB)

Correspondence Address: DEFILLO & ASSOCIATES, INC., P.O. Box 14104, Clearwater, FL, 33766, US

(21) Appl. No.: 12/445,946

(22) PCT Filed: Oct. 16, 2007
(86) PCT No.: PCT/GB07/03912

§ 371 Date: Apr. 17, 2009

(30) Foreign Application Priority Data
Oct. 17, 2006 (GB) 0620533.0

(51) Int. Cl. B65G 7/12; E04H 17/26

(52) U.S. Cl. 294/15

(57) ABSTRACT

A kit of tools for carrying and installing a post is disclosed. The kit comprises a pair of carrying tools for lifting a post. Each tool comprises a handle and a gripping portion formed as a loop for surrounding and supporting an object to be lifted and a stabilising formation that engages with an upper surface of an object to be lifted, the tools being used to lift the object from opposite ends. Additionally, the kit includes an installation tool for installing a post in a hole. The installation tool comprises first and second components that can be pivotally interconnected. Each component has a handle portion and a gripping portion. Upon interconnection of the components, the gripping portion forms a continuous loop through which a post can be passed. Movement of the handle portions in a direction upwardly in use causes gripping portions to move towards one another to grip a post placed between them.

### CROSS REFERENCE TO RELATED APPLICATION

This application is a national stage entry of PCT/GB2007/003912 filed Oct. 16, 2007, under the International Convention claiming priority over Great Britain application No. 0620533.0 filed Oct. 17, 2006.

### FIELD OF THE INVENTION

This invention relates to apparatus for lifting and handling articles. It has particular, but not exclusive, application to handling posts (such as fence posts or gate posts prior to and during their installation. The invention will be described with reference to is application to gate posts but it is to be understood that it is not limited to such an application.

### BACKGROUND OF THE INVENTION

Fences are often supported on concrete posts. Installation of these posts requires digging a hole in the ground and positioning the post upright in the hole, while is is permanently foxed there, for example by setting its lower end portion in concrete. These posts are typically heavy and awkward to handle, and this presents a risk of injury to anyone who is handling the post.

U.S. Pat. No. 5,161,781 discloses a tool for pulling fence posts that comprises two components that have formations that engage opposite sides of a post. However, one of the components engages the post with a length of metal bar, which could cause damage to a post. Moreover, loads are applied by the two components of the tool to the post at different points along its length, which applies a bending moment to the post. This is generally not a problem when the post is being pulled, since it will typically subsequently be discarded. However, it is undesirable when installing a new post.

### SUMMARY OF THE INVENTION

An aim of this invention is to provide tools that assist in the handling of posts prior to and during their installation.

From a first aspect, this invention provides a carrying tool for lifting an elongate object comprising a handle and a gripping portion, the gripping portion comprising a loop for surrounding and supporting an object to be lifted and a stabilising formation that engages with an upper surface of an object to be lifted.

Tools embodying this aspect of the invention are typically used in pairs, with one being applied to each end of the object, and each of the tools being carried by a respective person.

The handle portion and gripping portion can be constituted by portions of an elongate metal (typically steel) tube. The handle portion and gripping portion may be separated by a cranked portion. The handle portion and gripping portion may be substantially parallel. The gripping portion may include a loop that can surround an article to be lifted. The loop is preferably a close fit around the article. The loop may be welded to the tube, close to its end that is remote from the handle portion. The gripping portion may additionally include a stabilising formation carried on the tube to bear downwardly on the article being lifted. The stabilising formation may be constituted by an inverted U-shaped strip of metal. A lifting tool embodying this aspect of the invention is typically shaped and dimensioned to lift a concrete or metal fence post.

The invention typically provides a pair of similar tools that two people can use to lift a post from opposite ends.

From a second aspect, this invention provides an installation tool for installing a post comprising first and second components that can be pivotally interconnected, each component having a handle portion and a gripping portion, whereby upon interconnection of the components, the gripping portion forms a continuous loop through which a post can be passed, wherein movement of the handle portions in a direction upwardly in use causes gripping portions to move towards one another to grip a post placed between them.

The installation tool therefore grips the post in compression, so avoiding a bending moment being applied to the post.

The handle portion may be formed from a length of metal (e.g., steel) tube.

Each of the gripping portions may include a U-shaped steel component welded to the handle portion. The U-shaped steel components may include mutually engagable slots and spigots that can enable the components to be pivotally interconnected. For instance, one component may have a pair of slots and the other may have a pair of spigots. The U-shaped components may have legs that are spaced such that one can fit within the other with the legs closely spaced from one another. In such embodiments, the post is typically engaged by the base of the U-shaped component.

Each gripping portion may include a pad of resilient compressible material, such as rubber, to enhance the grip that it can apply to a post. This also ensures that force can be applied to the post over a surface area that ensures it applies a pressure that is low enough to minimise the risk of damage being caused to the post.

From a third aspect, this invention provides a kit for carrying and installing a post comprising a set of two carrying tools embodying the first aspect of the invention and an installation tool embodying the second aspect of the invention.

Further preferred and optional features will be apparent form the description of the preferred embodiments presented below.

### BRIEF DESCRIPTION OF THE DRAWINGS

Embodiments of the invention will now be described in detail, by way of example, and with reference to the accompanying drawings, in which:

FIG. 1 shows a post being carried prior to installation using carrying tools;

FIG. 2 shows a post being installed using an installation tool;

FIG. 3 shows the installation tool being removed from the post;

FIG. 4 shows the carrying tools;

FIGS. 5 and 6 are side and plan views of the components of the carrying tool;

FIGS. 7, 8 and 9 are, respectively, side, end and plan views of a first component of an installation tool embodying the invention; and

FIGS. 10, 11 and 12 are, respectively, side, end and plan views of a second component of an installation tool embodying the invention.

### DETAILED DESCRIPTION OF THE INVENTION

Installation of a post using tools embodying the invention is illustrated in FIGS. 1 to 3.

The post is carried to the place at which it is to be installed by two people each using one of a pair of identical carrying tools 10. The weight of the post can be securely and conveniently shared between the two people.

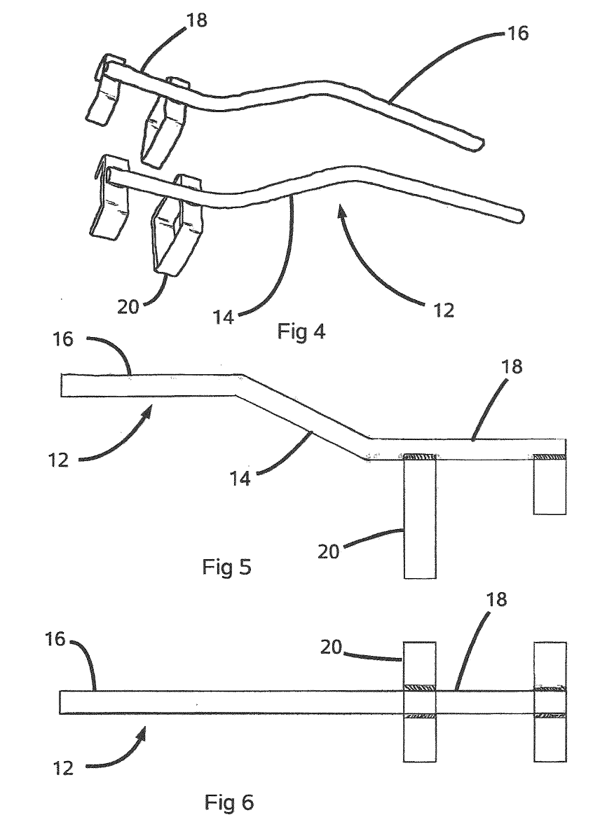

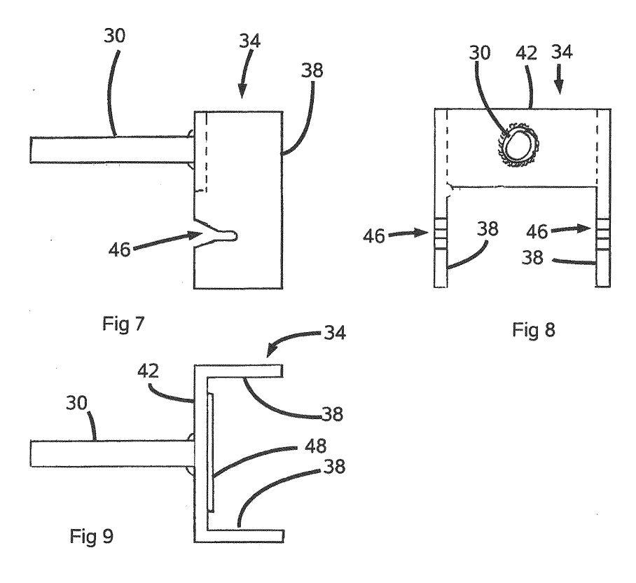

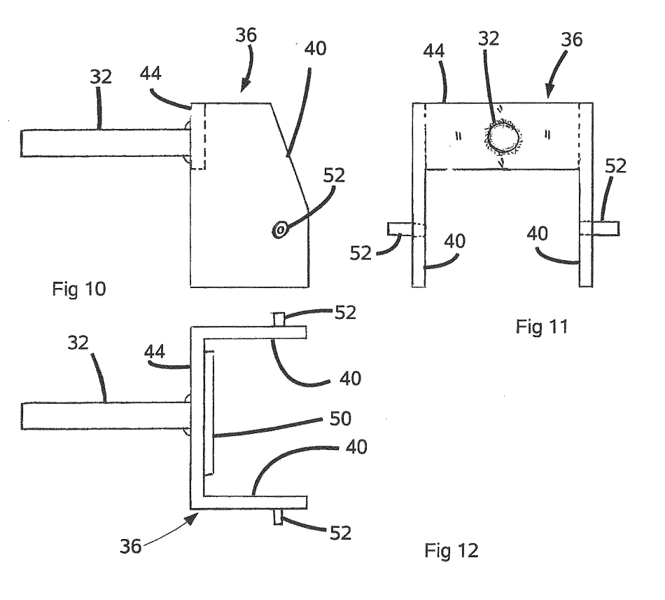

A carrying tool 10 is shown in more detail in FIGS. 4 to 6.

Each carrying tool 10 comprises an elongate steel tube 12. End portions of the tube 12 are parallel and interconnected by an intermediate cranked portion 14. A first of the parallel portions 16 serves as a handle for the tool 10. The handle may optionally be provided with a grip (not shown) to enhance a user's hold on the tool 10 and/or to cushion it.

The second of the parallel portions 18 carries connection formations that allow the tool 10 to carry a post. These will now be described.

The connection formations comprise a carrying loop 20 and a stabilising formation 22. The loop 20 is formed as a strip of steel formed into a generally rectangular shape with a size that enables it to fit closely around a post that is to be lifted. The loop 20 is welded, generally mid-way across one of its sides, onto the second of the parallel portion 18 close to the cranked portion 14. In use, the loop 20 is below the bar 12. The stabilising formation 22 is a U-shaped strip of steel that has a base and two legs. Centrally, the base of the stabilising formation 22 is welded to the bar 12, close to the end of the bar 12 remote from the handle portion 16, with its legs extending downwardly in use (such that the U-shape is inverted).

For use, a pair of carrying tools 10 are attached to a post by sliding their respective loops 20 onto a post 26, with their stabilising formations 22 over the post 26. The stabilising formation 22 bears upon the post with its legs to opposite sides of it. The base of the stabilising formation 22 applies a downward force to the post 26. The post 26 can then be lifted and moved in a stable manner by one person lifting each handle portion 16. This is clearly shown in FIG. 1.

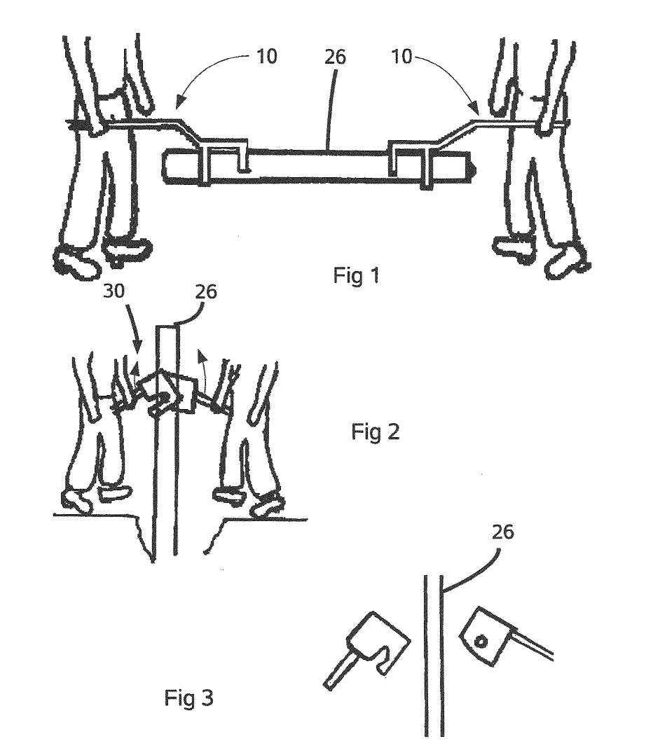

Once the post 26 has been carried to the location of its installation, it must be planted in a previously excavated hole in an upright position. To achieve this, an installation tool 30 is used, as shown in FIG. 3.

The installation tool 30 comprises first and second components that interconnect to cooperate for use.

Both the first and second components comprise a handle 30, 32 formed from steel tube welded to a gripping portion 34, 36. The gripping portions 34, 36 are U-shaped when seen in plan with the tool in use. Side walls of the gripping portions are formed from rectangular steel plates 38, 40. (In the case of the second component, the side walls have a chamfered region such that the components can interconnect without the plates interfering with the base of the first component.) The rectangular plates 38, 40 are interconnected by a steel base plate of the U 42, 44. The base plate 42, 44 is approximately one third the height of the side plates 38, 40 and is located at the top of the side plates 38,40 when the cool is in use. The handle 30, 32 is welded to a central part of the base plate 42, 44. Each base plate 42, 44 carries a rubber pad 48, 50 on its surface within the U.

In the first component, a slot 46 is formed in each side plate 38 that opens generally in the direction of the handle 30. The slot is below the bottom edge of the base plate 42. An outer part of the slot 46 is is tapered to broaden towards its opening.

In the second component, each side plate 40 carries a spigot 52. Each spigot 52 is welded to a respective plate 40 to project normally from it below the bottom edge of the base plate 44. The spacing between the side plates 40 of the second component is such that they can fit closely between the plates 38 of the first component.

For use, the components are first interconnected by passing the spigots 52 of the second component into the slots 46 of the first component. The broadened parts of the slots 46 help to guide the spigots into the slots 46. The two components can then pivot with respect to one another about the spigots 52. The gripping portions 34, 36 of the two components thereby form a rectangular gripping region.

A post 26 to be installed is passed into the rectangular gripping region. As the handles 30, 32 are lifted upwards, the components pivot and the base plates 42, 44 move towards one another. The post 26 is thereby gripped between the base plates 42, 44, grip being enhanced by the rubber pads 48, 50. The base plates 42, 44 apply their forces to opposite sides of the post 26 at substantially the same longitudinal position, such that the forces compress the post 26 but do not bend it. The weight of the post 26 serves to enhance the grip applied to it by the tool, so a heavy post will be gripped more securely than a lighter one. Two people, each using a respective one of the components, can then safely and securely manipulate the post, as shown in FIG. 2.

Once the post is installed, the handles of the first and second components are pivoted downwardly, and the components can then be separated, as shown in FIG. 3. The tool can then be removed without having to lift it over the top of the post.

1. A carrying tool for lifting an elongate object comprising:
a handle and
a gripping portion, the gripping portion comprising a loop for surrounding and supporting an object to be lifted and a stabilising formation that engages with an upper surface of an object to be lifted.

2. A carrying tool according to claim 1 in which the handle portion and gripping portion are constituted by portions of an elongate metal tube.

3. A carrying tool according to claim 1 or claim 2 in which the handle portion and the gripping portion are separated by a cranked portion.

4. A carrying tool according to claim 1 in which the handle portion and gripping portion are substantially parallel.

5. A carrying tool according to claim 1 in which the gripping portion includes a loop that can surround an article to be lifted.

6. A carrying tool according to claim 5 in which the loop is a close fit around an article to be lifted.

7. A carrying tool according to claim 5 in which the loop is welded to the tube, close to its end that is remote from the handle portion.

8. A carrying tool according to claim 1 in which the gripping portion additionally includes a stabilising formation carried on the tube to bear downwardly on the article being lifted.

9. A carrying tool according to claim 1 in which the stabilising formation is constituted by an inverted U-shaped strip of metal.

10. A carrying tool according to claim 1 that is shaped and dimensioned to lift a concrete or metal fence post.

11. A set of carrying tools for lifting an elongate object comprising a pair of similar tools according to claim 1 that two people can use to lift a post from opposite ends.

12. An installation tool for installing a post comprising:
first and second components that can be pivotally interconnected, each component having a handle portion and a gripping portion, whereby upon interconnection of the components, the gripping portion forms a continuous loop through which a post can be passed, wherein movement of the handle portions in a direction upwardly in use causes gripping portions to move towards one another to grip a post placed between them.

13. An installation tool for installing a post according to claim 12 in which the handle portion is formed from a length of metal tube.

14. An installation tool for installing a post according to claim 12 in which each of the gripping portions includes a U-shaped metal component welded to the handle portion.

15. An installation tool for installing a post according to claim 14 in which the U-shaped metal components include mutually engagable slots and spigots that can enable the components to be pivotally interconnected.

16. An installation tool for installing a post according to claim 15 in which one U-shaped metal component has a pair of slots and the other U-shaped metal component has a pair of spigots.

17. An installation tool for installing a post according to claim 14 in which the U-shaped metal components have legs that are spaced such that one can fit within the other with the legs closely spaced from one another.

18. An installation tool for installing a post according to claim 17 in which the post is typically engaged by the base of the U-shaped component.

19. An installation tool for installing a post according to claims 12 in which each gripping portion includes a pad of resilient compressible material, such as rubber, to enhance the grip that it can apply to a post.

20. A kit of tools for carrying and installing a post comprising a set of two carrying tools according to claim 11 and an installation tool according to claim 12.
